(19) United States
(12) Patent Application Publication
(10) Pub. No.: US 2026/0309269 A1
(43) Pub. Date: Oct. 8, 2026

(54) Connecting Assembly and Supporting Device

(71) Applicants: Yanping Feng, Jiangmen (CN); Chunming Chen, Jiangmen (CN)

(72) Inventors: Yanping Feng, Jiangmen (CN); Chunming Chen, Jiangmen (CN)

(21) Appl. No.: 19/682,177

(22) Filed: May 19, 2026

(30) Foreign Application Priority Data
Apr. 30, 2026 (CN) 2026206186248

(51) Int. Cl. F16M 13/00

(52) U.S. Cl. CPC F16M 13/00; F16M 2200/025; F16M 2200/061

(57) ABSTRACT

A connecting assembly and a supporting device includes at least one fixing arm and at least one adjustment arm; the at least one fixing arm is provided with a plurality of first positioning parts; the plurality of first positioning parts are evenly distributed on two sides of a central axis line of the at least one fixing arm; the at least one adjustment arm is provided with a second positioning part; the second positioning part cooperates with any one of the plurality of first positioning parts forming a detachable connection; the supporting device includes at least two connecting assemblies; a user can adjust the supporting device to various sizes to reach a wider application range.

### CROSS-REFERENCE TO RELATED APPLICATIONS

The present application claims the benefit of Chinese Patent Application No. 2026206186248 filed on Apr. 30, 2026, the contents of which are hereby incorporated by reference.

### Technical Field

The present invention belongs to the technical field of connecting devices, and in particular relates to a connecting assembly and supporting device.

### Technical Background

In daily life and industrial applications, various types of support frames, such as tables, shelves, toilet racks and couch tables, are widely used for holding daily items. Most conventional support frames are provided with two or four support legs to stand on the ground for support, yet such kind of conventional support frames often shake or tilt due to uneven force or lateral force, resulting in poor stability in use. In order to solve this problem, a common design is to add a diagonal or twisted connecting component on the support frame to form a triangular or intersecting support structure, so as to effectively improve the overall stiffness and the anti-tilt capability.

However, the existing connecting component is generally formed integrally, and the size thereof is fixedly adapted to a support frame product of a specific specification; thus, such integrally formed connecting component lacks flexibility. In practical use, there are significant differences in the size requirements of the support frame in different application scenarios. For example, the toilet frame needs to adjust the span and height according to a outline size of the toilet; the couch table needs to match different lengths of the couch; but the integrally formed connecting component is unable to adjust its length or angle as required, resulting that one support frame fails to adapt to various size requirements, thereby greatly limiting the generality and using convenience of the product.

### Invention Content

In order to overcome the shortcomings of the prior art, the present invention provides a connecting assembly and a supporting device. The supporting device has high flexibility, which can be adjusted into various sizes and applicable for a wide range of scenarios.

The technical solution adopted by the present invention for solving the technical problem is:

The connecting assembly comprises at least one fixing arm and at least one adjustment arm; the at least one fixing arm is provided with a plurality of first positioning parts; the plurality of first positioning parts are evenly distributed on two sides of a central axis line of the at least one fixing arm; the at least one adjustment arm is provided with a second positioning part; the second positioning part cooperates with any one of the plurality of first positioning parts forming a detachable connection.

Further, a first mounting hole is arranged on an end of the at least one adjustment arm far away from the second positioning part; a second mounting hole is arranged on two ends of the at least one fixing arm respectively.

Further, each of the plurality of first positioning parts is designed as a bulge; the second positioning part is designed as a recess; the bulge and the recess are compatible with each other.

Further, the each of the plurality of first positioning parts is designed as the recess; the second positioning part is designed as the bulge; the bulge and the recess are compatible with each other.

Further, the at least one fixing arm is further provided with a plurality of first limiting parts; the plurality of first limiting parts are evenly distributed on the two sides of the central axis line of the at least one fixing arm; the at least one adjustment arm is provided with a second limiting part; when the second positioning part is connected with any one of the plurality of first positioning parts, the at least one adjustment arm rotates around relative to the at least one fixing arm until the second limiting part is clamped with any one of the plurality of first limiting parts.

Further, the connecting assembly further comprises a plurality of locking component and a plurality of connecting blocks; the at least one adjustment arm is provided with a sliding hole; each one of the plurality of locking components goes through the sliding hole and the second mounting hole in sequence so as to reach at one of the plurality of locking components to fasten the at least one adjustment arm on the at least one fixing arm.

Further, the at least one fixing arm is provided with a sliding groove; the second mounting hole is arranged within the sliding groove.

Further, the at least one fixing arm is provided with a plurality of limiting boards; the plurality of limiting boards are arranged on two sides of the plurality of first positioning parts; the plurality of limiting boards raise up along a vertical direction.

Further, the connecting assembly further comprises two locking components; the at least one adjustment arm is provided with the sliding hole; a plurality of second locking holes are arranged on the two sides of the central axis line of the at least one fixing arm; a plurality of connecting blocks are arranged on a bottom surface of the at least one fixing arm; the at least one adjustment arm is provided with a first locking hole; the first locking hole is adjacent to the second positioning part; one of the two locking components goes through the first locking hole and the second locking hole so as to reach at one of the plurality of connecting blocks to fasten the at least one adjustment arm on the at least one fixing arm; an other of the two locking components goes through the sliding hole and the second mounting hole so as to reach at another one of the plurality of connecting blocks to fasten the at least one adjustment arm on the at least one fixing arm.

The present invention also provides a supporting device, which comprises at least two connecting assemblies as described above; a third mounting hole is arranged on a middle position of each one of the two connecting assemblies; the third mounting hole is located on the at least one fixing arm of the connecting assembly; the two connecting assemblies are hingedly connected via a connecting component together with the third mounting hole.

The beneficial effects of the present invention are as follows:

The present invention provides a connecting assembly and a supporting device, and the user only need to select one adjustment arm to connect to one end or two ends of the fixing arm, so that he/she can get one supporting device in different size; such kind of the connecting assembly and the supporting device are not only suitable to apply to support daily items, but also allows the user to change or adjust its size and specification according to his/her actual needs, in other words, such kind of the connecting assembly and the supporting device are widely used in different situations; besides, the user can fold up the supporting device by rotating the fixing arms so as make the fixing arms and adjustment arms closed together in a folded state, in this way, it helps to reduce a storage space, make it convenient to transport and save transportation costs.

### DESCRIPTION OF FIGURES

FIG. 1 is a front schematic view of a fixing arm of Embodiment 1;

FIG. 2 is an axial side schematic view of the fixing arm of Embodiment 1;

FIG. 3 is an axonometric view of an adjustment arm of Embodiment 1;

FIG. 4 is a schematic view of the adjustment arm of Embodiment 1;

FIG. 5 is a schematic view showing the adjustment arm connected with the fixing arm in Embodiment 1;

FIGS. 6A-6C are schematic views showing a connecting component adjusted in different sizes of Embodiment 1;

FIGS. 7A-7C are schematic views showing the connecting component comprising two adjustment arms adjusted in different sizes of Embodiment 1;

FIG. 8 is a schematic view of a supporting device of Embodiment 1;

FIG. 9A-9C are schematic views showing the supporting device of Embodiment 1 in a folded state;

FIG. 10 is a schematic view showing the fixing arm connected with one adjustment arm of Embodiment 2;

FIG. 11 is an exploded view showing the fixing arm connected with one adjustment arm of Embodiment 2;

FIG. 12 is a schematic diagram of the supporting device in Embodiment 2;

FIG. 13 is another schematic diagram of the supporting device in Embodiment 2;

Description of marks in figures:
1—connecting assembly;
11—fixing arm; 110—central axis line; 111—first positioning part; 112—first limiting part; 113—second mounting hole; 114—sliding groove; 115—connecting block; 116—limiting board; 117—third mounting hole;
12—adjustment arm; 120—second positioning part; 121—second limiting part; 122—first mounting hole; 123—sliding hole;
13—locking component; 131—first locking hole; 132—second locking hole;
2—supporting device; 21—connecting component.

### DETAILED DESCRIPTION OF THE EMBODIMENTS

The present embodiment only shows an explanation of the present invention and it is not a limitation to the present invention. The skilled in the art can make modifications to this embodiment as needed without making any creative contributions after reading this specification, which are always protected by the patent law as long as they are within the scope of the claims of the present invention.

It should be noted that when an element is referred to be“fixed to” or “arranged on” another element, the element may be directly on the another element or indirectly on the another element; when an element is referred to be “connected to” another element, the element can directly connects to the other element or indirectly connects to the other element.

It should be understood that, a plurality of terms included “length”, “width”, “up”, “down”, “front”, “rear”, “left”, “right”, “vertical”, “horizontal”, “top”, “bottom”, “inner”, “outer” and so on; orientation or position relationships indicated by the terms are based on the drawings, which are only used to facilitate description of the present invention and simplify the description, rather than indicating or implying that the device or element referred to must have a specific orientation, and be constructed and operated in a specific orientation; therefore that cannot be construed as a limitation on the present invention.

In addition, terms such as “first” and “second” are used herein for purposes of description and are not intended to indicate or imply relative importance or significance or to imply the number of indicated technical features. Thus, the features defined by “first” and “second” may explicitly or implicitly include one or more of the features. In the description of some inventions, the meaning of “a plurality of” is two or more, unless specified otherwise.

### Embodiment 1

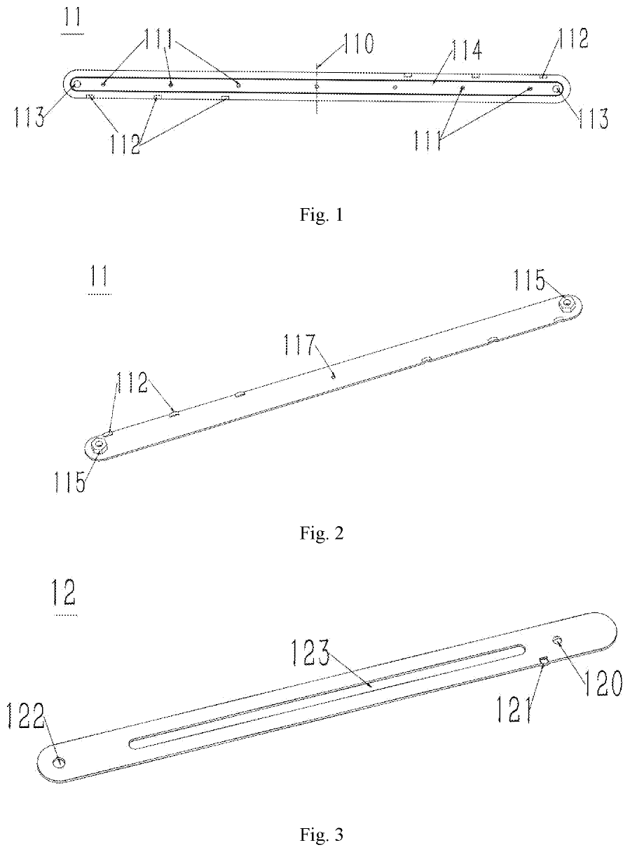

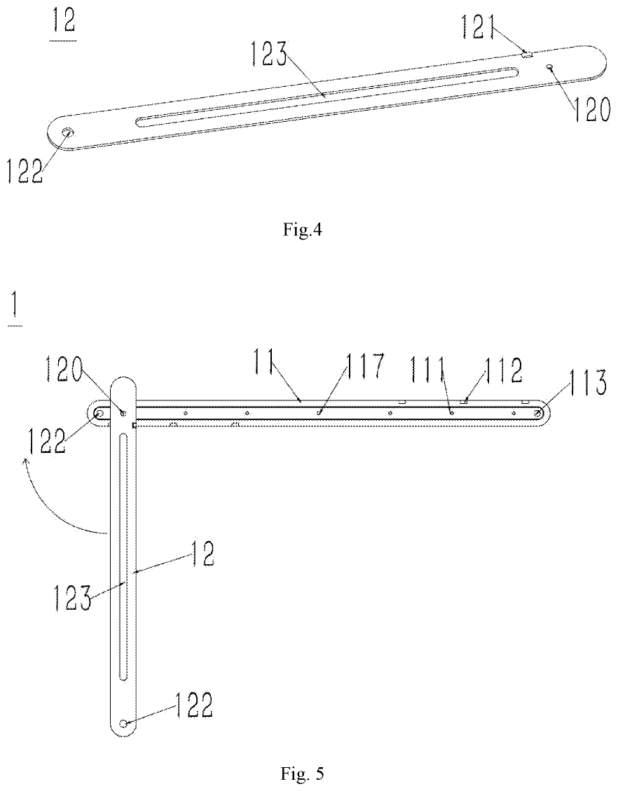

Referring to FIG. 1 to FIG. 7C, this embodiment provides a connecting assembly 1, which includes at least one fixing arm 11 and at least one adjustment arm 12; the at least one fixing arm 11 is provided with a plurality of first positioning parts 111; the plurality of first positioning parts 111 evenly distribute on two sides of the central axis line 110 of the at least one fixing arm 11; the at least one adjustment arm 12 is provided with a second positioning part 120; the second positioning part 120 cooperates with any one of the plurality of first positioning parts 111 forming a detachable connection.

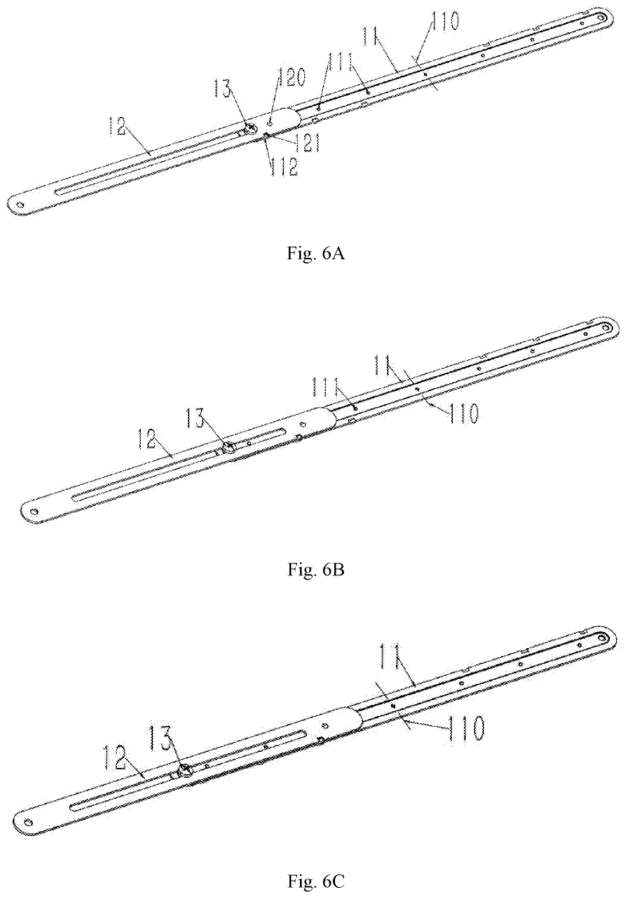

Referring to FIG. 6A to FIG. 6C, a side of the at least one fixing arm 11 is connected with one adjustment arm 12; a user can adjust a total length of the adjustment arm 12 and the fixing arm 11 by installing the one adjustment arm 12 on one of the plurality of first positioning parts 111 at different positions.

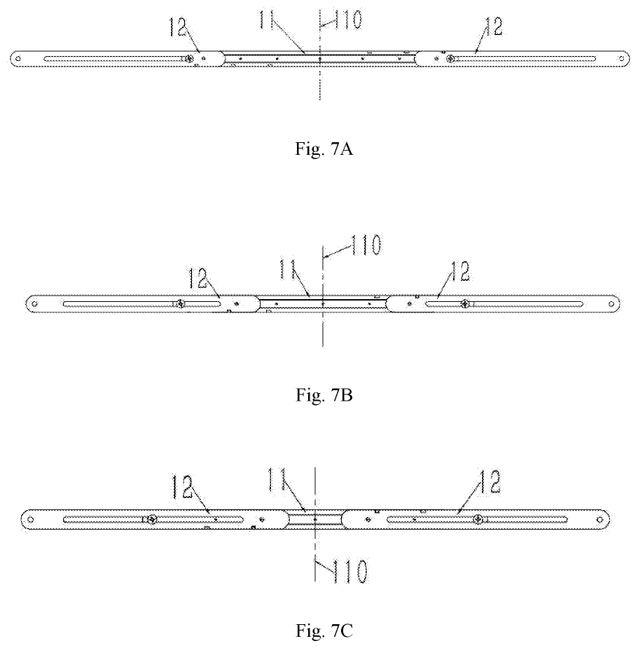

Referring to FIG. 7A to FIG. 7C, two adjustment arms 12 are connect to two sides of the least one fixing arm 11; that is, the user only need to have the two adjustment arms 12 installed on two of the plurality of first positioning portions 111 at different positions of two sides of the least one fixing arm 11, so as to form one connecting assembly 1 in different length.

The user can assemble one connecting assembly 1 with one adjustment arm 12 and one fixing arm 11, that is, having the one adjustment arm 12 connected on one side of the fixing arm 11; or the user can assemble one connecting assembly 1 with two adjustment arms 12 and one fixing arm 11, that is, the adjustment arms 12 are respectively connected on two sides of the fixing arm 11; by assembling the adjustment arm 12 on one of the plurality of first positioning portions 111 at different positions, the user can get one connecting assembly 1 in a size based on his/her needs.

Among which, an end of the at least one adjustment arm 12 far away from the second positioning part 120 is provided with a first mounting hole 122; the first mounting hole 122 usually is used to connect to an external object; a second mounting hole 113 is respectively arranged on two ends of the at least one fixing arm 11; the user can have the at least one fixing arm 11 connected to the external object via the second mounting hole 113; or the user can have the at least one fixing arm 11 connected with one adjustment arm 12 via the second mounting hole 113, and then have the at least one fixing arm 11 connected to the external object via the one adjustment arm 12.

In Embodiment 1, each of the plurality of first positioning parts 111 is designed as a bulge; the second positioning part 120 is designed as a recess; the bulge and the recess are compatible with each other.

In practical application, each of the plurality of first positioning parts 111 is able to be designed as the recess; the second positioning 120 part is able to be designed as the bulge; the bulge and the recess are compatible with each other.

Preferably, the fixing arm 11 is provided with a plurality of first limiting parts 112; the plurality of first limiting parts 112 evenly distribute at the two sides of a central axis line 110 of the fixing arm 11; the adjustment arm 12 is provided with a second limiting part 121; when the first positioning part 111 connects to the second positioning part 120, the adjustment arm 12 rotates relative to the fixing arm 11 until the second limiting part 112 matches with any one of the plurality of first limiting parts 121; in other words, once the second limiting part 112 is matched with one of the plurality of first limiting parts 121, the adjustment arm 12 stops rotating.

By providing the plurality of first limiting parts 112 and the second limiting part 121, it helps to limited a relative rotation angle between the fixing arm 11 and the adjustment arm 12; in this way, it prevents an excessive rotation, so as to reduce abrasion between the fixing arm 11 and the adjustment arm 12, and prolong a service life of the connecting assembly 1.

In Embodiment 1, both the plurality of first limiting parts 112 and the second limiting part 121 are designed as an arc-shaped recess structure; a recess direction of the plurality of first limiting parts 112 and the second limiting part 121 are the same.

Taking FIG. 5 as an example, the user rotates the adjustment arm 12 along a clockwise direction indicated by an arrow in the FIG. 5, the second limiting part 121 gradually approach to one of the plurality of first limiting parts 112, and then abuts against the one of the plurality of first limiting parts 112; as shown in FIG. 6, the one of the plurality of first limiting parts 112 and the second limiting part 121 are connected with each other forming a rigid limitation fit; at this moment, the adjustment arm 12 cannot rotate any more, which define precisely a maximum relative rotation angle between the fixing arm 11 and the adjustment arm 12, thereby preventing a structural deformation, connection failure or use safety dangers caused by the excessive rotation.

In practical application, the plurality of first limiting parts 112 and the second limiting part 121 may also be designed as an arc-shaped protrusion structure, which is not limited herein.

Preferably, the connecting assembly 1 further includes a plurality of locking components 13 and a plurality of connecting blocks 115; the at least one adjustment arm 12 is provided with a sliding hole 123; every one of the plurality of locking components 13 goes through the sliding hole 123 and the second mounting hole 113 in sequence; then the every one of the plurality of locking components 13 connects to every one of the plurality of connecting blocks 115 respectively.

In Embodiment 1, the sliding hole 123 is designed as a waist-shaped hole extending along a length direction of the adjustment arm 12.

As an implementation condition of the present invention, the plurality of connecting blocks 115 are nuts, the plurality of locking components 13 are screws; the plurality of connecting blocks 115 are arranged on the at least one fixing arm 11 by a connection process such as welding; or the plurality of connecting blocks 115 and the fixing arm 11 are separately made.

Further, the at least one fixing arm 11 is provided with a sliding groove 114; the second mounting hole 113 is respectively arranged in the sliding groove 114 at the two end of the at least one fixing arm 11.

The connecting assembly 1 of the present invention is installed in steps as follows:
First, the user needs to determine an entire length of the connecting assembly 1 according to his/her actual needs, then select a specific one of the plurality of first positioning parts 111 on the fixing arm 11, and next connect the adjustment arm 12, to the fixing arm by fixing the second positioning part 120 on the specific one of the plurality of first positioning parts 111, so as to realize primary positioning;
Second, rotate the adjustment arm 12 until one of the plurality of first limiting parts 112 connected with the second limiting part 121, at this moment, the adjustment arm 12 cannot continue to rotate, then the adjustment arm 12 and the fixing arm 11 connected together;
Finally, have one locking component 13 going through the sliding hole 123 and the second mounting hole 113 in sequence, and then make the one locking component 13 fixed on the connecting block 115, in this way, the adjustment arm 12 is connected with the fixing arm 11; the assembling operation is completed.

Comparing with a conventional plane connection structure, the locking component 13 of the present invention is used to tightly press and fix a partial section of the adjustment arm 12 on a surface of the sliding groove 114, thereby preventing the adjustment arm 12 from deviating its position, which has a better fixing effect.

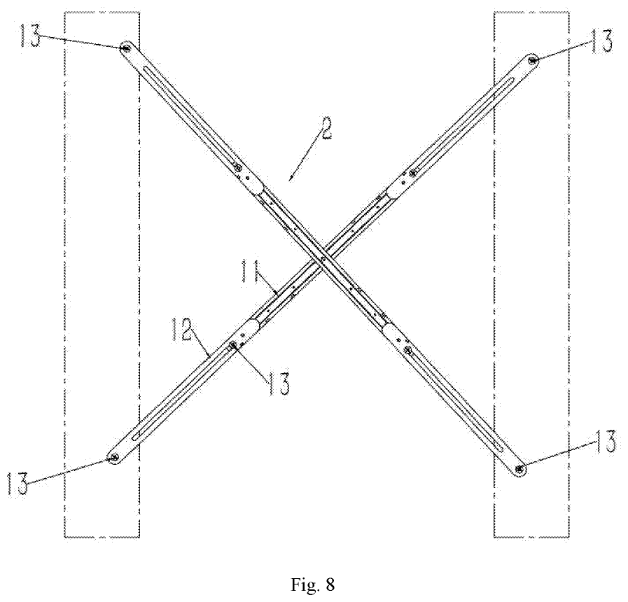

Referring to FIG. 8, the present invention further provides a supporting device 2, which comprises at least two connecting assemblies 1; a third mounting hole 117 is arranged on a middle position of the fixing arm 11 of each of the two connecting assemblies 1; a connecting component 21 goes through the third mounting holes 117 of the two connecting assemblies 1 so as to make the two connecting assemblies 1 hingedly connected together; thanks to such design, the user can rotate and fold the two fixing arms 11 of the two connecting assemblies 1 at different angles; then, the user can make the adjustment arms 12 connected to designated first positioning parts 111, in this way, the user adjust the total length of each of the two connecting assemblies 1; finally, the user can fix the supporting device 2 on the external object via the plurality of locking components 13; in other words, the user needs to use some locking components 13 to fix the adjustment arms 12 one by one on the external object, in details, one locking component 13 goes through the first mounting hole 122 and then fasten the locking component 13 one by one; as shown in FIG. 8, dot-dash-dot broken lines depict the external object where the supporting device 2 installed or connected.

The supporting device 2 is suitable to use with objects like a table, a cabinet, or a toilet rack; except for a stable supporting function, the supporting device 2 also able to change its size and specification according to actual needs, so as to remain in widespread use.

The two fixing arms 11 of the supporting device 2 can be rotated and folded up; besides, the adjustment arms 12 can also be rotated and folded up; in this way, when the user does not need to use the supporting device 2, he/she can rotate and fold up the supporting device 2 so as to reduce a storage space; in addition, make it easy to transport and save transportation cost.

It should be specially noted that: the user first need to loosened the plurality of locking components 13, so as to release a fixed relationship between the adjustment arm 12 and the sliding groove 114, and then to release a connection relationship of the second positioning portion 120 with one of the plurality of first positioning portions 111; in this way, the user can fold up the adjustment arms 12 easily, for the adjustment arms 12 can be rotated around the locking component 13 as a pivot point.

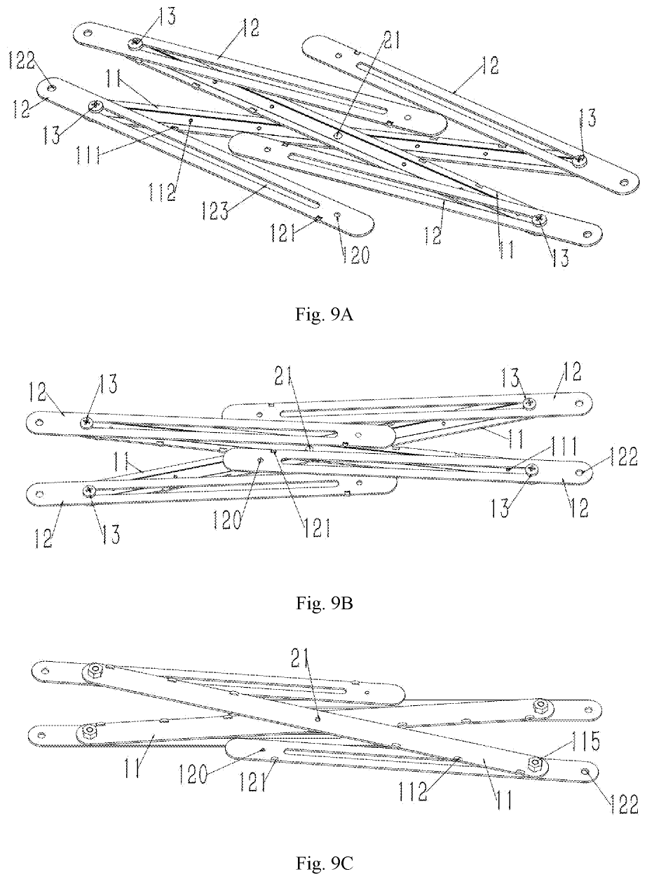

Referring to FIGS. 9A to 9C, when the user needs to completely fold up the supporting device 2 to reach a minimal storage space, he/she needs to loosen the plurality of locking components 13, so as to release the connection relationship of the second positioning part 120 with the plurality of first positioning parts 111; then, he/she pushes each of the adjustment arms 12 to slide along the sliding hole 123, so as to make an other end of the each of the adjustment arms 12 close to the locking components 13, in specific, an end provided with the first mounting hole 112 moves close to the locking components 13 on the fixing arm 11; finally, he/she rotates the adjustment arms 12 to make the supporting device 2 in a completely folded state, which is shown in FIG. 9B and FIG. 9C.

### Embodiment 2

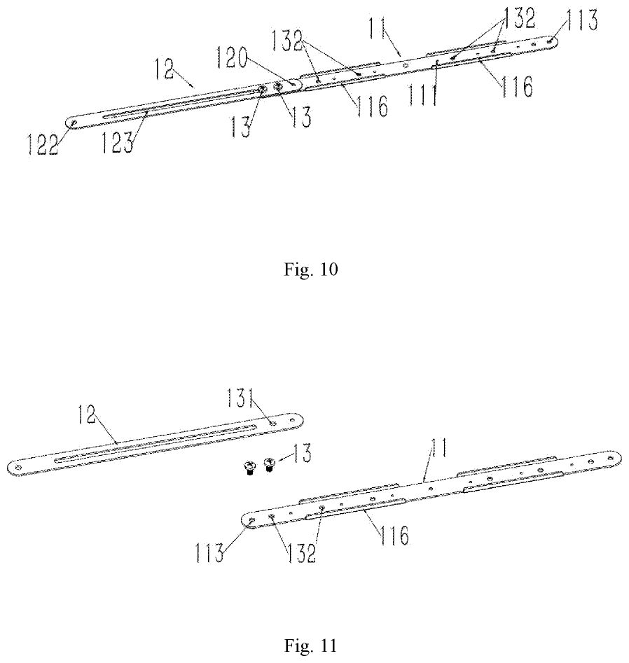

Referring to FIGS. 10 to 13, the Embodiment 2 differs from the Embodiment 1 in the fixing arm 11, that is, in Embodiment 2, the fixing arm 11 is further provided with a plurality of limiting boards 116; the plurality of limiting boards 116 are arranged on two sides of the plurality of first positioning part 111; the plurality of limiting boards 116 raise up along a vertical direction, forming a raised edge.

A plurality of second locking holes 132 are arranged on an upper surface of the fixing arm 11; a plurality of connection blocks 115 are arrange on a bottom surface of the fixing arm 11; the plurality of second locking holes 132 are respectively matched with the plurality of connection blocks 115 one by one.

The adjustment arm 12 is provided with a first locking hole 131; the first locking hole 131 is adjacent to the second positioning part 120; the connecting assembly 1 further comprises two locking components 13; one of the two locking components 13 goes through the first locking hole 131 and the second locking hole 132 and then fixes on one of the plurality of connecting blocks 115; an other of the two locking components 13 goes through the sliding hole 123 and the second mounting hole 113 and then fixes on another one of the plurality of connecting blocks 115; the two locking components 13 together limit the adjustment arm 12 without shaking but help to guide the adjustment arm 12 slide in a straight line direction, which ensures a firm connection of the fixing arm 11 and the adjustment arm 12.

The plurality of limiting boards 116 and the two locking components 13 are used to limit the adjustment arm 12 without shaking from right to left, but straightly slides along the fixing arm 11, thereby adjusting the total length of the adjustment arm 12 and the fixing arm 11.

It should be specially noted that, no matter how to adjust a relative position of the adjustment arm 12 and the fixing arm 11, the one of the two locking components 13 maintains connected the adjustment arm 12 on the fixing arm 11 via the sliding hole 123 and the second mounting hole 113; the other one of the two locking components 13 maintains connected the adjustment arm 12 on the fixing arm 11 via the first locking hole 131 and any one of the second locking holes 132.

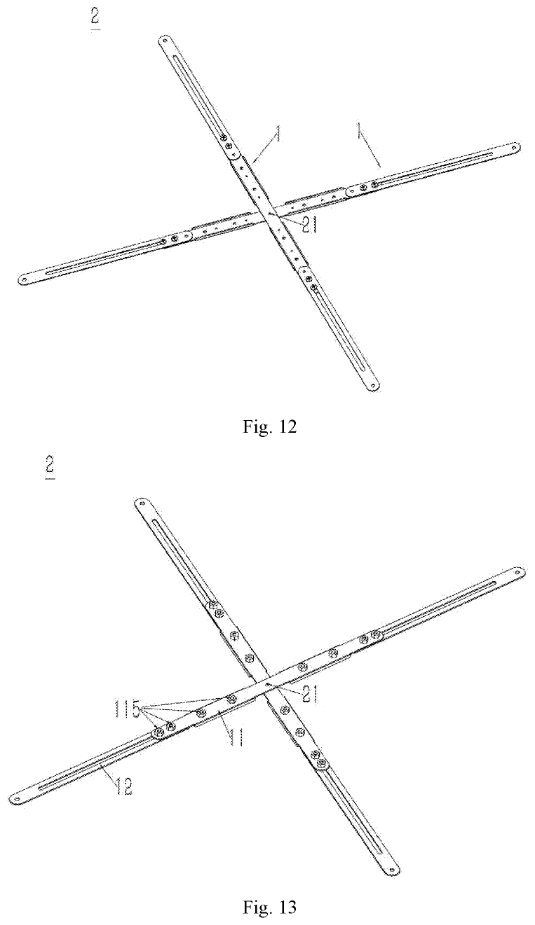

In the Embodiment 1, it has not only shown that the connecting assembly 1 includes one fixing arm 11 connected with one adjustment arm 12 at one end of the fixing arm 11, but also has shown that the connecting assembly 1 includes one fixing arm 11, and two ends of the fixing arm 11 are respectively connected with one adjustment arms 12; these shows that the user can adjust a total length of the connecting assembly 1 in two ways, thus, the Embodiment 2 will not illustrate again. FIG. 12 and FIG. 13 show the supporting device 2 assembled by the connecting assembly 1 of the Embodiment 2 from different perspectives.

It could be understood that under the guidance of the above embodiments, those skilled in the art can combine various implementation methods in the above embodiments to obtain technical solutions of multiple implementation methods.

The above description is only a preferred embodiment of the present invention and is not to limit the present invention. Any modifications, equivalent substitutions and improvements made within the spirit and principles of the present invention should be included in the scope of protection of the p resent invention.

1. A connecting assembly, comprising at least one fixing arm and at least one adjustment arm; the at least one fixing arm is provided with a plurality of first positioning parts; the plurality of first positioning parts are evenly distributed on two sides of a central axis line on the at least one fixing arm; the at least one adjustment arm is provided with a second positioning part; the second positioning part cooperates with any one of the plurality of first positioning parts to form a detachable connection.

2. The connecting assembly according to claim 1, wherein a first mounting hole is arranged on an end of the at least one adjustment arm far away from the second positioning part; a second mounting hole is arranged on two ends of the at least one fixing arm respectively.

3. The connecting assembly according to claim 1, wherein each of the plurality of first positioning parts is designed as a bulge; the second positioning part is designed as a recess; the bulge and the recess are compatible with each other.

4. The connecting assembly according to claim 1, wherein the each of the plurality of first positioning parts is designed as the recess; the second positioning part is designed as the bulge; the bulge and the recess are compatible with each other.

5. The connecting assembly according to claim 1, wherein the at least one fixing arm is further provided with a plurality of first limiting parts; the plurality of first limiting parts are evenly distributed on the two sides of the central axis line on the at least one fixing arm; the at least one adjustment arm is provided with a second limiting part; when the second positioning part is connected with any one of the plurality of first positioning parts, the at least one adjustment arm rotates around relative to the at least one fixing arm until the second limiting part is clamped with any one of the plurality of first limiting parts.

6. The connecting assembly according to claim 2, further comprising a plurality of locking components and a plurality of connecting blocks; the at least one adjustment arm is provided with a sliding hole; each one of the plurality of locking components goes through the sliding hole and the second mounting hole in sequence so as to reach at one of the plurality of connecting blocks to fasten the at least one adjustment arm on the at least one fixing arm.

7. The connecting assembly according to claim 2, wherein the at least one fixing arm is provided with a sliding groove; the second mounting hole is arranged within the sliding groove.

8. The connecting assembly according to claim 1, wherein the at least one fixing arm is provided with a plurality of limiting boards; the plurality of limiting boards are arranged on two sides of the plurality of first positioning parts; the plurality of limiting boards raise up along a vertical direction.

9. The connecting assembly according to claim 8, further comprising two locking components; the at least one adjustment arm is provided with the sliding hole; a plurality of second locking holes are arranged on the two sides of the central axis line of the at least one fixing arm; a plurality of connecting blocks are arranged on a bottom surface of the at least one fixing arm; the at least one adjustment arm is provided with a first locking hole; the first locking hole is adjacent to the second positioning part; one of the two locking components goes through the first locking hole and the second locking hole so as to reach at one of the plurality of connecting blocks to fasten the at least one adjustment arm on the at least one fixing arm; an other of the two locking components goes through the sliding hole and the second mounting hole so as to reach at another one of the plurality of connecting blocks to fasten the at least one adjustment arm on the at least one fixing arm.

10. A supporting device, comprising at least two connecting assemblies according to claim 1, wherein a third mounting hole is respectively arranged in a middle position of the two connecting assemblies; the two connecting assemblies are hingedly connected via a connecting component together with the third mounting hole.
